(19) United States
(12) Patent Application Publication
(10) Pub. No.: US 2026/0311453 A1
(43) Pub. Date: Oct. 8, 2026

(54) SYSTEM AND METHOD FOR IMAGE CLASSIFICATION

(71) Applicant: Accenture Global Solutions Limited, Dublin (IE)

(72) Inventors: Vicknesh MANO, Singapore (SG); Ramine TINATI, Singapore (SG)

(73) Assignee: Accenture Global Solutions Limited, Dublin (IE)

(21) Appl. No.: 19/169,513

(22) Filed: Apr. 3, 2025

(51) Int. Cl. G06V 10/764; G06V 10/56; G06V 10/774; G06V 10/776

(52) U.S. Cl. CPC G06V 10/764; G06V 10/56; G06V 10/774; G06V 10/776

(57) ABSTRACT

Method, system, and non-transitory computer-readable medium for image classification are disclosed. In an example, a first image is obtained from a plurality of images. Further, display color values are extracted for each predesignated area of the first image. Each predesignated area is then mapped to a pantone color code based upon the display color values. The first image is converted into a sequence of pantone color codes based on the mapping. Furthermore, the pantone color codes are encoded into a matrix of values “0” and “1”. The matrix is then transmitted to a large language image classifier model that is prompted to classify the matrix into one of a first or second category. Also, the first or second category is outputted to a user interface. Training data to indicate agreement or disagreement with the first or second category is received. The model is then adjusted based on the training data.

### TECHNICAL FIELD

Various examples described herein relate generally to a method, system, and non-transitory computer readable medium for image classification. Specifically, disclosed examples are directed to techniques for image classification using large language models (LLMs).

### BACKGROUND

Image classification is a fundamental task in the field of computer vision and machine learning. Generally, the image classification involves the process of categorizing an image into one of several predefined classes or categories based on its content. Traditional image classification techniques typically involve manually engineered features or template matching. These methods, however, often struggle to maintain accuracy when dealing with large datasets, variations in image quality, or complex patterns within the image.

### SUMMARY

Implementations of the present disclosure are generally directed to image classification. More particularly, implementations of the present disclosure are directed to techniques for classifying images using large language image classifier models.

In some examples, aspects of the subject matter described herein provide a system for image classification. The system may include at least one memory configured to store machine executable instructions and at least one processor communicatively coupled with the at least one memory. Further, the at least one processor is configured to execute the machine executable instructions to obtain a first image from the plurality of images and extract a plurality of display color values for each predesignated area of the first image. Based upon the plurality of display color values associated with the each predesignated area, the at least one processor is configured to map the each predesignated area to a pantone color code. Furthermore, the at least one processor is configured to convert the first image into a sequence of pantone color codes based on the mapping. Moreover, the at least one processor is configured to encode the sequence of pantone color codes into a matrix of values “0” and “1”. In addition, the at least one processor is configured to transmit the matrix to a large language image classifier model and prompt the large language image classifier model to classify the matrix into one of a first category or a second category. Also, the at least one processor is configured to output the first category or the second category to a user interface. The at least one processor is then configured to receive training data to indicate agreement or disagreement with the first category or the second category. Based on the training data, the alt least one processor adjusts the large language image classifier model.

The present disclosure further describes a method for determining labels for the plurality of images by the at least one processor provided herein. The present disclosure also describes non-transitory computer-readable medium coupled to the at least one processor and having instructions stored thereon which, when executed by the at least one processor, cause the at least one processor to perform operations in accordance with the method described herein.

It is appreciated that method in accordance with the present disclosure can include any combination of the aspects and features described herein. That is, the method in accordance with the present disclosure is not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment that may be used to execute implementations of the present disclosure.

FIG. 2 depicts an example architecture of an image classification system for classifying images, in accordance with implementations of the present disclosure.

FIG. 3 depicts an example process flow of generation of a sequence of pantone color codes, in accordance with implementations of the present disclosure.

FIG. 4 depicts an example process flow of training a large language image classifier model for image classification, in accordance with implementations of the present disclosure.

FIGS. 5A-5B depict example process flows of binary color encoding, in accordance with implementations of the present disclosure.

FIG. 5C is an example schematic diagram depicting aggregation of pixels, in accordance with implementations of the present disclosure.

FIG. 6 is a flow diagram that presents an example method for performing image classification, in accordance with implementations of the present disclosure.

FIG. 7 depicts a block diagram of an example computer system, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series, and the like.

The term “a” means “one or more” unless the context clearly indicates a single element.

“First,” “second,” etc., re labels to distinguish components or blocks of otherwise similar names but does not imply any sequence or numerical limitation.

“And/or” for two possibilities means either or both stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

Image classification has been a cornerstone of computer vision research and has made significant strides with the advent of Artificial Intelligence (AI) and deep learning technologies. Convolutional Neural Networks (CNNs), in particular, have become the standard for processing image data, where existing methods typically analyze pixel or Red, Green and Blue (RGB) values of images to extract features and perform classification tasks. However, the existing pixel/RGB-based methods begun to reach a performance plateau due to limited information from raw pixels. For example, traditional image classification methods rely heavily on raw pixel or RGB data, treating images as arrays of color values. However, these methods do not fully capture the semantic content of images, such as texture, lighting conditions, depth, or higher-order relationships between objects. As a result, models trained purely on pixel data are limited in their ability to generalize across varied environments or contexts.

Also, to achieve high performance, pixel or RGB-based algorithms often require large amounts of labeled data. Gathering and labeling large datasets is resource-intensive, and even with vast quantities of data, the performance of such models can still degrade in the presence of noisy, ambiguous, or unusual images. This creates significant challenges in training robust models, especially for specialized applications where labeled data is sparse. Further, the models that rely on pixel values or RGB values often require high-memory hardware and long training times to achieve high accuracy, especially for high-resolution images or large-scale datasets. This limits the scalability and efficiency of such methods for real-time applications or those with constrained computational resources.

Implementations of the present disclosure classify images to determine respective labels using large language image classifier models. The present disclosure converts the image uploaded by a user into a sequence of colors by converting each pixel into a closest matching pantone color. Further, sequences of color codes are generated. The sequence of color codes is then converted into the encoded color sequences, i.e., a binary matrix. The encoded color sequences are pushed to the custom large language image classifier model for training. Based on the training, the custom large language image classifier model predicts a label of the image as a good image or a bad image. For example, the bad image indicates that the image may contain bad content and is within a predetermined criteria and the good image may indicate that the image may contain good content and is outside the predetermined criteria. The predetermined criteria may include one or more of nudity, violence, illegal content, eating disorders, regulated products, abuse, bullying, discriminatory and the like.

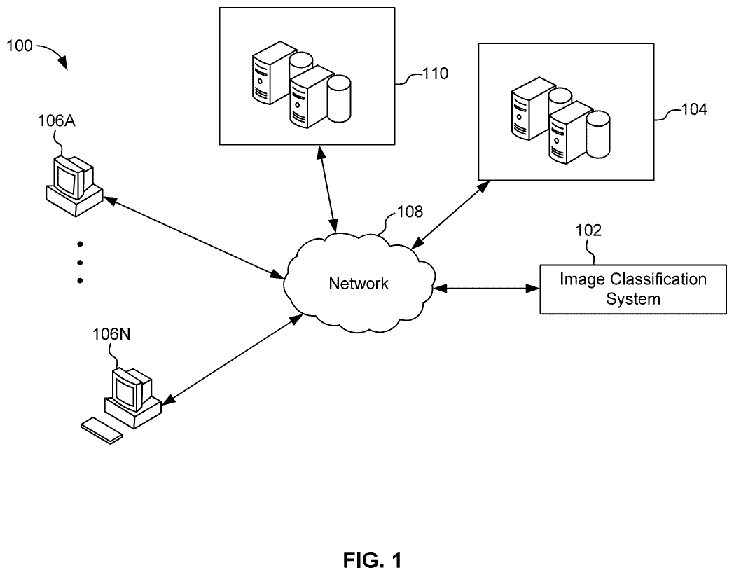

FIG. 1 depicts an example environment 100 that may be used to execute implementations of the present disclosure. The example environment 100, shown in FIG. 1, includes an image classification system 102, a storage device 104, a plurality of user devices 106A-106N and a model database 110. The image classification system 102, the storage device 104, model database 110 and the user devices 106A-106N may communicate with each other using a network 108. In some examples, the network 108 may include a Local Area Network (LAN), a Wide Area Network (WAN), the Internet, or a combination thereof. In some examples, the network 108 may be accessed over a wired and/or a wireless communication link.

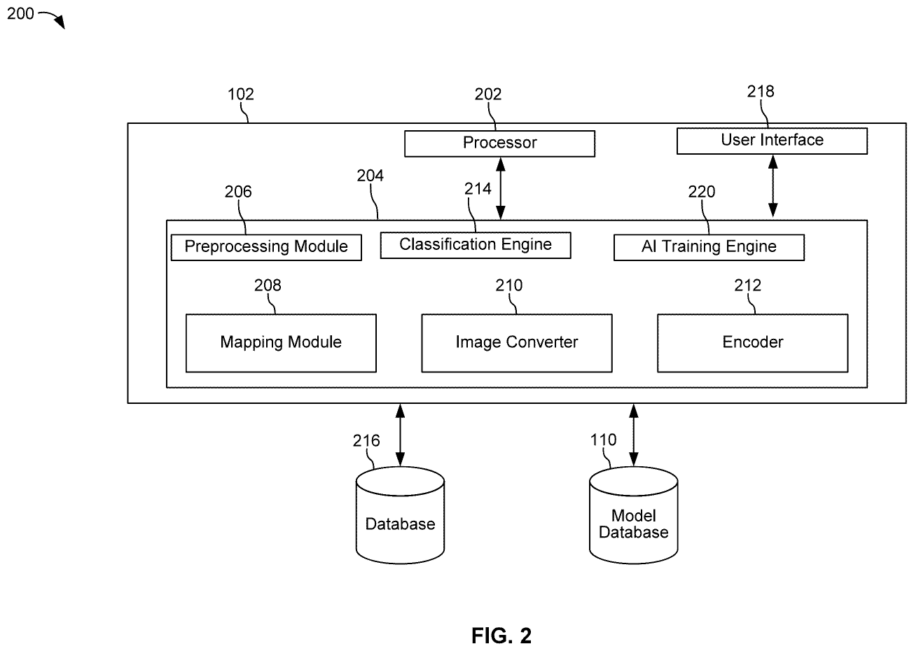

The image classification system 102 is a computing system or a computing device that receives images from a user of one of the user devices 106A-106N. The image classification system 102 may then process and classify the images to determine respective labels using a large language image classifier model in the model database 110. In some examples, the image classification system 102 may include internal or external servers, quantum computers, desktops, laptops, smartphones, tablets, and/or the like. It is contemplated that implementations of the present disclosure may be realized with any appropriate type of computing device or computing platform. In some examples, the image classification system 102 may display one or more Graphical User Interfaces (GUIs) that enable the users of the user devices 106A-106N to interact with a computing platform executing image classification applications. Examples of the computing platform may include content delivery platforms, multimedia-based platforms, and/or the like. Interacting with the computing platform may include providing feedback during the process of image classification. For example, the image classification system 102 is described in more detail with reference to FIG. 2.

Further, the storage device 104 may include any standalone server or any type of computing device that are part of a cloud computing environment for storing data that is generated during the process of image classification. Various examples depicting the image classification are described in detail in conjunction with FIGS. 2-5.

FIG. 2 depicts an example architecture 200 of the image classification system 102, in accordance with implementations of the present disclosure. As depicted in FIG. 2, the image classification system 102 is communicatively coupled with a database 216 (e.g., the storage device 104) and the model database 110. For example, the database 216 can be a client database or a metadata database. In some examples, the model database 110 may include one or more large language image classifier models (also referenced herein as Large Language Models (LLMs), Generative Artificial Intelligence (GAI)) models, foundation models, and/or the like). In an implementation, the large language image classifier models may include pre-trained LLMs or generated LLMs. The pre-trained LLMs may be general-purpose GAI models like large deep learning neural networks, which may be trained using a broad range of generalized and unlabeled training data to perform one or more tasks, such as, human computer interactions (e.g., question and answering), automating process execution, process planning, generating step-by-step procedures for the process execution, performing data analysis, and/or the like. While implementations of the present disclosure are described in further detail herein with non-limiting reference to the large language image classifier models, it is contemplated that implementations of the present disclosure may be realized using any appropriate foundation models or Machine Learning (ML) models, or Artificial Intelligence (AI) models.

As depicted in FIG. 2, the image classification system 102 includes a processor 202, a memory 204 and a user interface 218. The image classification system 102 may also include other components such as communication interfaces, Input/Output (I/O) devices, and so on (not shown in FIG. 2). The processor 202 may include one or more processors. Examples of the one or more processors may include, but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the processor 202 may be programmed to execute computer-readable instructions stored in the memory 204 (also referenced herein as non-transitory computer-readable medium (NTCRM)) for performing operations according to the present disclosure. The memory 204 may be non-transitory or non-volatile medium, such as a magnetic disk or solid-state non-volatile memory or volatile medium such as Random Access Memory (RAM), and/or the like.

The image classification system 102 further includes a preprocessing module 206, a mapping module 208, an image converter 210, an encoder 212, a classification Engine 214, and an AI training engine 220 as depicted in FIG. 2. The preprocessing module 206, the mapping module 208, the image converter 210, the encoder 212, the classification Engine 214 and the AI training engine 220 may be stored in the memory 204 and provided as a downloadable library including the computer-readable instructions. The preprocessing module 206, the mapping module 208, the image converter 210, the encoder 212, the classification Engine 214 and the AI training engine 220 may be executed by the processor 202 communicatively coupled with the memory 204 for performing image classification. In some implementations, the preprocessing module 206, the mapping module 208, the image converter 210, the encoder 212, the classification Engine 214 and/or the AI training engine 220 may leverage multiple customized logics for performing its intended functions. In some examples, multiple customized logics may include Generative Artificial Intelligence (Gen AI) models, Deep Learning (DL) models, deep neural networks, and/or the like.

In an example implementation, the preprocessing module 206 may obtain a plurality of images from one or more of the user devices 106A-106N via the user interface 218. In some examples, the images may be collected over time and stored in any external database(s). The preprocessing module 206 may store the obtained images in the database 216 (as depicted in FIG. 2). In an implementation, the obtained images may be unencrypted or pre-decrypted. In some examples, the preprocessing module 206 may transform the images into a pre-defined format by resizing, normalizing, noise reduction, gray scale reduction, rotation, alignment and the like.

Further, the preprocessing module 206 may extract a plurality of display color values for each predesignated area of a first image of the images. For example, the each predesignated area includes a plurality of pixels, so that a length of a sequence of pantone color codes is within a maximum dimension of the large language image classifier model. Furthermore, the mapping module 208 may map the each predesignated area to a pantone color code based upon the plurality of display color values associated with the each predesignated area. In addition, the image converter 210 may convert the first image into the sequence of the pantone color codes based on the mapping.

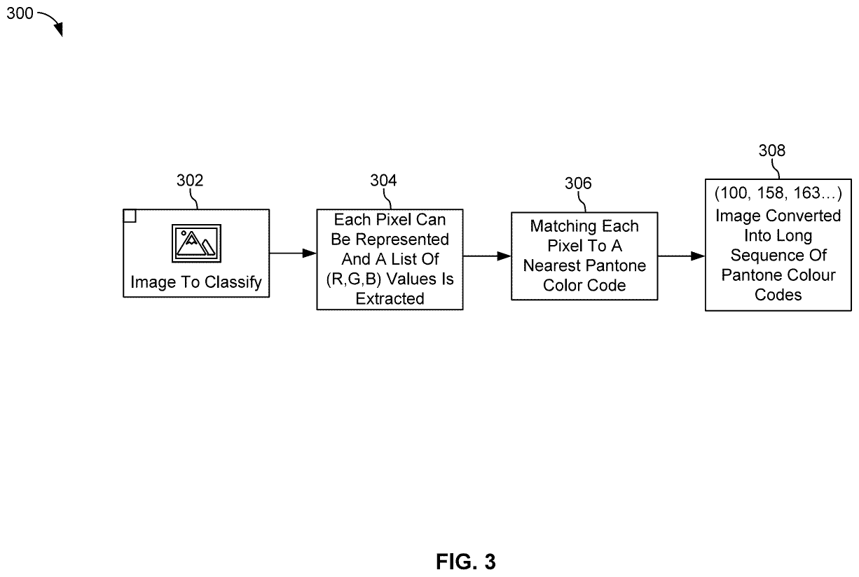

For example, FIG. 3 that depicts an example process flow 300 of generation of a sequence of pantone color codes, in accordance with implementations of the present disclosure. In an example implementation, the preprocessing module 206 obtains an image 302 from one of the user devices 106A-106N for classification. Further, the preprocessing module 206 represents each pixel in the image and extracts a list of (R, G, B) values 304 of each pixel. For example, images are made of pixels, each with a RGB value. For example, for a small image, RGB values of each pixel are extracted for processing. For large images, pixels may be first aggregated by a smallest square (e.g., 4/16) to fit into the large language image classifier model's maximum length dimension. RGB values of the aggregated pixel are then extracted for processing. Furthermore, the mapping module 208 may map the RGB values of each pixel to a nearest pantone color code 306 based on Euclidian distance between the RGB values and the nearest Pantone color code). In addition, the image converter 210 may convert the image into a long sequence of pantone color codes 308. For example, the image converter 210 may convert the image into a long sequence of pantone color codes, such as 100, 158, 163 . . . , which can be an evolving limit. In this example, each number in the sequence of the pantone color codes corresponds to a pantone color code which corresponds to the RGB value of each pixel in the image.

In some examples, if the image is a small image (e.g., an image of a size 1870×1870 pixels), then each pixel's RGB value may be averaged and mapped to the nearest pantone color code, thus reducing color space from >16 million RGB values to 1800 distinct pantone color values). For example, pantone color code is selected based on nearest sorted pantone color based on a RGB Euclidian distance. In this example, the RGB Euclidean distance may be a way of measuring difference or distance between two colors in a RGB color space.

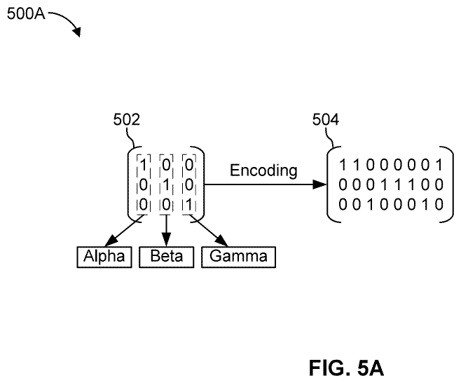

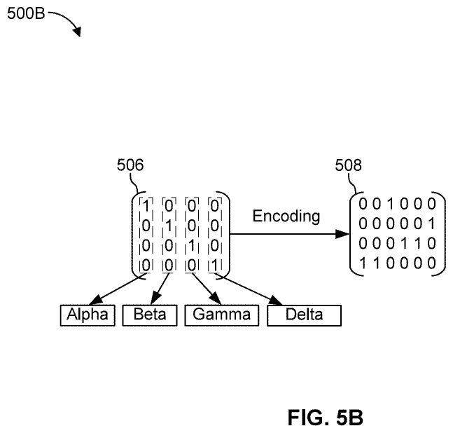

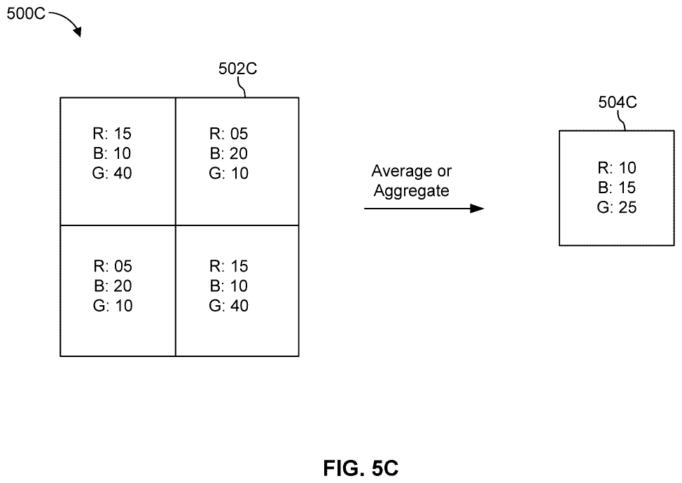

If the image is a large image having a size greater than 1870×1870 pixels, the image is first aggregated (e.g., RGB values of four pixels are averaged into RGB values of one pixel) before classification to fit into the large language image classifier model's maximum sequence length (which can expand with larger model architectures). FIG. 5C is an example schematic diagram 500C depicting aggregation of pixels, in accordance with implementations of the present disclosure. In the schematic diagram 500C, four input pixels 502C from an image are averaged or aggregated into one pixel 504C. The four input pixels 502C includes various RGB values as shown in the diagram 500C. For the pixel 504C, RGB values are determined by averaging or aggregating the RGB values of the four input pixels.

Also, the encoder 212 may encode the sequence of pantone color codes into a matrix of values “0” and “1”. In some examples, the encoder 212 may convert the sequence of pantone color codes into a series of color codes denoted by a combination of the values “0” and “1” to represent each pantone color code of the sequence of pantone color codes and create the matrix of the series of color codes. For example, FIGS. 5A-5B depict example process flows 500A and 500B of binary color encoding, in accordance with implementations of the present disclosure. In this example, the process flow 500A depicts binary color encoding process for three raw colors named Alpha, Beta and Gamma 502. Further, the three raw colors are encoded to a color sequence of Alpha, Alpha, Gamma, Beta, Beta, Beta, Gamma, Alpha and a matrix 504 is created for the color sequence.

Also, the process flow 500B depicts binary color encoding process for four raw colors named Alpha, Beta, Gamma and Delta 506. Further, the four raw colors are encoded to a color sequence of Delta, Delta, Alpha, Gamma, Gamma, Beta and a matrix 508 is created for the color sequence.

Further, the classification engine 214 may transmit the matrix to the large language image classifier model. The classification engine 214 may then prompt the large language image classifier model to classify the matrix into one of a first category or a second category, along with a probability score for each category. In an aspect, a sum of probability scores is 1 when there are two categories. In some examples, the first category may indicate that the first image is within a predetermined criteria and the second category may indicate that the first image is outside the predetermined criteria. The predetermined criteria may include one or more of nudity, violence, illegal content, eating disorders, regulated products, abuse, bullying, discriminatory and the like. Furthermore, the classification engine 214 may output the first category or the second category to the user interface 218. In an example implementation, the classification engine 214 may prohibit display of the first image on the user interface 218 if the matrix is classified into the first category. Also, the classification engine 214 may store the output in the database 216 for monitoring and/or adjusting (i.e., re-training) the large language image classifier model.

In addition, the AI training engine 220 may receive training data to indicate agreement or disagreement with the first category or the second category. For example, the training data may include feedback (i.e., true positive or false positive) received from the user one or more user devices 106A-106N. The feedback (i.e., true positive or false positive) may be received based on historical analysis. The AI training engine 220 may then adjust the large language image classifier model based on the training data.

In an example implementation, the AI training engine 220 may establish a training dataset for training the large language image classifier model by repeatedly performing the below steps on a predetermined number of images. In this example implementation, the training dataset is established by obtaining each of the predetermined number of images from the plurality of images. Further, a plurality of display color values is extracted for each predesignated area of the each of the predetermined number of images. Based upon the plurality of display color values associated with the each predesignated area, the each predesignated area is mapped to a pantone color code. Furthermore, the each of the predetermined number of images are converted into a sequence of pantone color codes based on the mapping. The sequence of pantone color codes may be then converted into a matrix of values “0” and “1”. In addition, the matrix is transmitted to the large language image classifier model and the large language image classifier model is prompted to classify the matrix into a one of the first category or the second category. The first category or the second category is outputted to the user interface. Moreover, training data to indicate agreement or disagreement with the first category or the second category is received. The large language image classifier model is then adjusted or re-trained based on the training data.

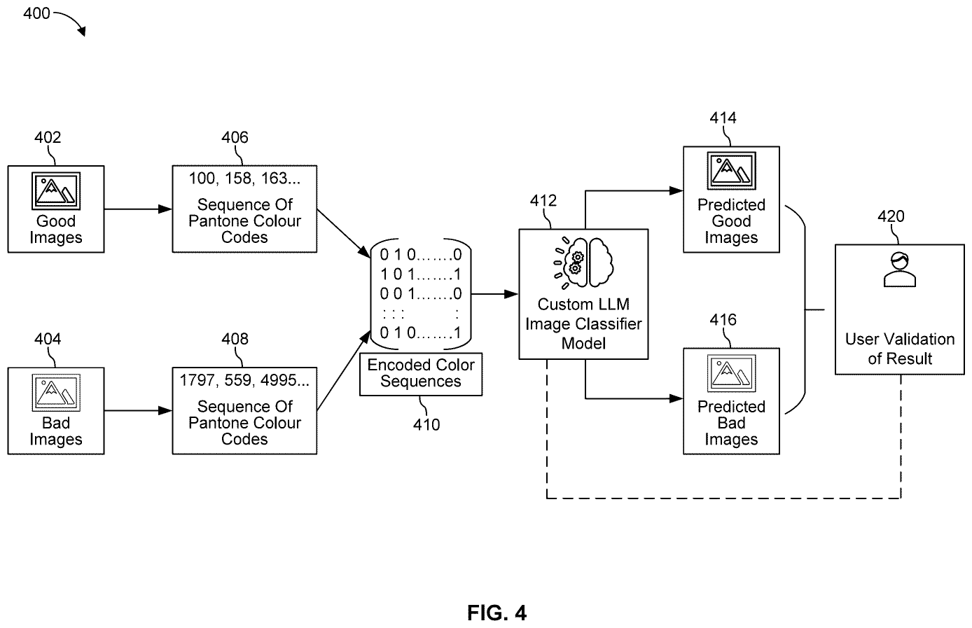

Referring now to, FIG. 4 depicts an example process flow 400 of training the large language image classifier model for image classification, in accordance with implementations of the present disclosure. In the process flow 400, good images 402 and bad images 404 are obtained. Further, the good image 402 and the bad images 404 are converted into a sequence of pantone color codes 406 and 408, respectively. In some examples, an image is converted into a long sequence (up to 3.5 million based on current maximum input of the large language image classifier model) of pantone color codes for classification. Further, the good images and the bad images may include different patterns hidden in the sequence of pantone color codes, enabling AI classifications. The good image may include a pattern 100, 158, 163 . . . in the sequence of pantone color codes and the bad image may include a pattern 1797, 559, 4995 . . . in the sequence of pantone color codes.

In addition, the sequences of pantone color codes are encoded into encoded color sequences 410. For example, an AI encoding of text or number into 1/0 matrix is performed prior to AI consumption for training/scoring. Moreover, the encoded 1/0 Matrix is inputted into the large language image classifier model for scoring 412. Further, the large language image classifier model classifies the images as predicted good images 414 and predicted bad images 416. Also, the user of the one or more user devices 106A-106N may perform validation of results 420 of the classification and provide feedback on the predicted good images 414 and predicted bad images 416 for adjusting or re-training the large language image classifier model for efficient classification. For example, the feedback may include true positive feedback or false positive feedback that can be used for learning or re-training of large language image classifier model.

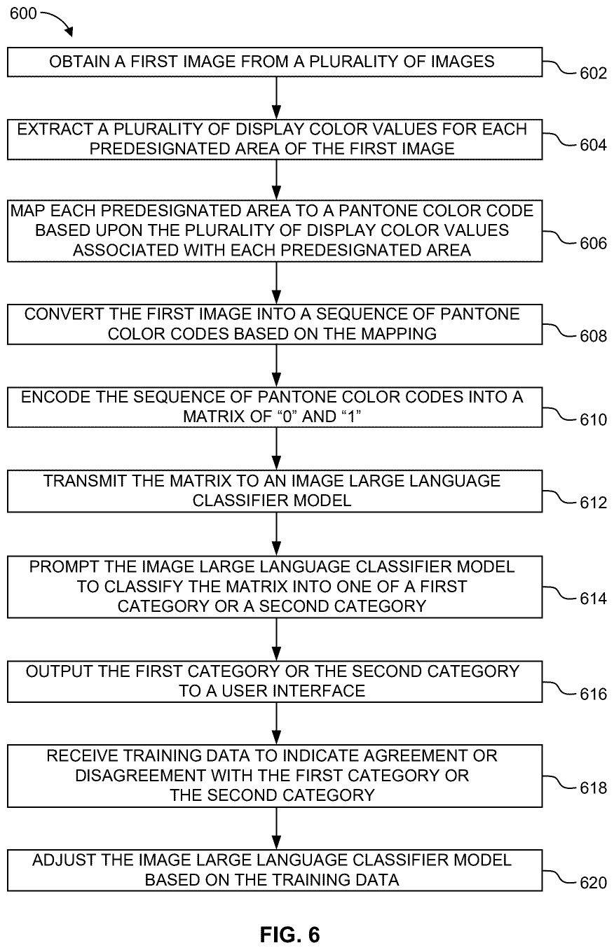

FIG. 6 is a flow diagram that presents an example computer implemented method 600 for performing image classification to determine labels for a plurality of images, in accordance with implementations of the present disclosure. In some implementations, the method 600 may be executed by the processor 202 (including the one or more processors), as described in relation to FIGS. 1-5.

In an example implementation, the method 600 may include obtaining 602 a first image from the plurality of images. The method 600 may further include extracting 604 a plurality of display color values for each predesignated area of the first image. For example, each predesignated area may include a plurality of pixels, so that a length of the sequence of the pantone color codes is within a maximum dimension of a large language image classifier model.

Furthermore, the method 600 may include mapping 606 the each predesignated area to a pantone color code based upon the plurality of display color values associated with the each predesignated area. Moreover, the method 600 may include converting 608 the first image into a sequence of pantone color codes based on the mapping. In addition, the method 600 may include encoding 610 the sequence of pantone color codes into a matrix of values “0” and “1”. In some examples, the method 600 may include encoding by converting the sequence of pantone color codes into a series of color codes denoted by a combination of the values “0” and “1” to represent each pantone color code of the sequence of pantone color codes and creating the matrix of the series of color codes. Also, the method 600 may include transmitting 612 the matrix to the large language image classifier model.

Further, the method 600 may include prompting 614 the large language image classifier model to classify the matrix into one of a first category or a second category. For example, the first category may indicate that the first image is within predetermined criteria and the second category may indicate that the first image is outside the predetermined criteria. In this example, the predetermined criteria may include one or more of nudity, violence, illegal content, eating disorders, regulated products, abuse, bullying, discriminatory and the like.

Furthermore, the method 600 may include outputting 616 the first category or the second category to a user interface. Moreover, the method 600 includes receiving training data 618 to indicate agreement or disagreement with the first category or the second category. Also, the method 600 includes adjusting 620 the large language image classifier model based on the training data.

For example, the method 600 may further include establishing a training dataset by repeatedly performing on a predetermined number of images. In this example, the method 600 may include obtaining each of the predetermined number of images from the plurality of images. Further, the method 600 may include extracting a plurality of display color values for each predesignated area of the each of the predetermined number of images. Furthermore, the method 600 may include mapping the each predesignated area to a pantone color code based upon the plurality of display color values associated with the each predesignated area. In addition, the method 600 may include converting the each of the predetermined number of images into a sequence of pantone color codes based on the mapping. Moreover, the method 600 may include converting the sequence of pantone color codes into a matrix of values “0” and “1”. Also, the method 600 may include transmitting the matrix to the large language image classifier model. Further, the method 600 may include prompting the large language image classifier model to classify the matrix into one of the first category or the second category. The method 600 may then include outputting the first category or the second category to the user interface. Furthermore, the method 600 may include receiving training data to indicate agreement or disagreement with the first category or the second category. The method 600 may then include adjusting the large language image classifier model based on the training data.

In another example, the method 600 may further include receiving a plurality of classification images. Further, the method 600 may include extracting a plurality of display color values for each of the plurality of classification images. The method 600 may then include mapping the each predesignated area to a pantone color code based upon the plurality of display color values associated with the each predesignated area. Furthermore, the method 600 may include converting each of the classification images into a sequence of pantone color codes based on the mapping. In addition, the method 600 may include converting the sequence of pantone color codes into a matrix of values “0” and “1”. The method 600 may then include transmitting the matrix to the large language image classifier model. Moreover, the method 600 may include prompting, for each of the plurality of classification images, the large language image classifier model to classify the matrix into the first category or the second category. Also, the method 600 may include prohibiting display of the plurality of classification images in the first category.

Implementations of the present disclosure provide technical solutions to multiple technical problems that arise in the context of image classification. The proposed methodology leveraging AI for image analysis by converting images into a sequence of color codes. Therefore, the classification is performed using sequence of color codes with improved accuracy, confidence level, rate of true positives, and/or the like. This, in turn, may improve response time, conserve computing resources, networking resources, and/or the like that otherwise have been overutilized in analyzing the risk scores, unnecessarily addressing false positive, false negatives, and/or the like.

Implementations of the present disclosure further enable AI to differentiate and classify the images using differences in color code sequences between “good images” and “bad images”. Therefore, the proposed methodology improves overall classification of the images.

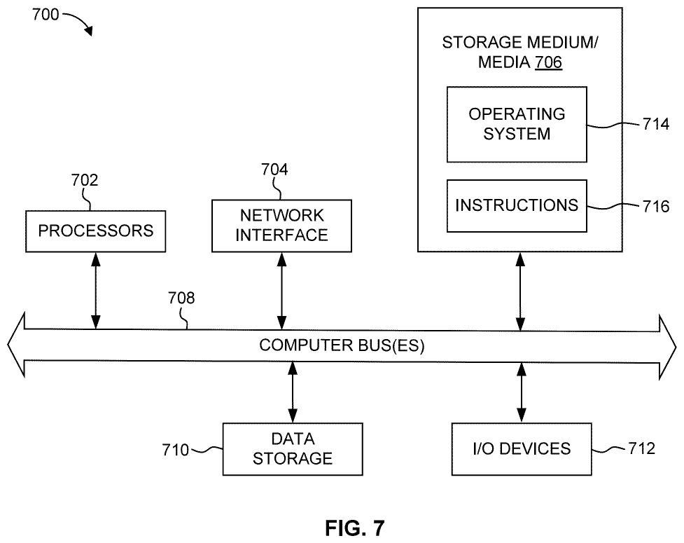

FIG. 7 depicts a block diagram of an example computer system (i.e., the image classification system 102), in accordance with implementations of the present disclosure. More particularly, computing machines such as desktops, laptops, smartphones, tablets, and wearables which may be used to perform the data ingestion. The computer system 700 may include additional components not shown and that some of the process components described may be removed and/or modified. In another example, a computer system 700 may be deployed on external-cloud platforms such as cloud, internal corporate cloud computing clusters, organizational computing resources, and/or the like.

The computer system 700 includes processor(s) 702, such as a central processing unit, ASIC or another type of processing circuit, input/output devices 704, such as a display, mouse keyboard, etc., a network interface 706, such as a Local Area Network (LAN), a wireless 802.11x LAN, a 3G or 4G mobile WAN or a WiMax WAN, and a computer-readable medium 708. Each of these components may be operatively coupled to a bus 710. The computer-readable medium 708 may be any suitable medium that participates in providing instructions to the processor(s) 702 for execution. For example, the computer-readable medium 708 may be non-transitory or non-volatile medium, such as a magnetic disk or solid-state non-volatile memory or volatile medium such as RAM. The instructions or modules stored on the computer-readable medium 708 may include machine-readable instructions 712 executed by the processor(s) 702 that cause the processor(s) 702 to perform the methods and functions of the image classification system 102.

The image classification system 102 may be implemented as software stored on a non-transitory processor-readable medium and executed by the processor(s) 702. For example, the computer-readable medium 708 may store an operating system 714, such as MAC OS, MS WINDOWS, UNIX, or LINUX, and code, for the image classification system 102. The operating system 714 may be multi-user, multiprocessing, multitasking, multithreading, real-time, and the like. For example, during runtime, the operating system 714 is running and the code for the image classification system 102 is executed by the processor(s) 702.

The computer system 700 may include a data storage 716, which may include non-volatile data storage. The data storage 716 stores any data used or generated by the image classification system 102.

The network interface 706 connects the computer system 700 to internal systems for example, via a LAN. Also, the network interface 706 may connect the computer system 700 to the Internet. For example, the computer system 700 may connect to web browsers and other external applications and systems via the network interface 706.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer includes, or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 702 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet. The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
at least one memory configured to store machine executable instructions; and
at least one processor communicatively coupled with the at least one memory and configured to execute the machine executable instructions to:
obtain a first image from a plurality of images;
extract a plurality of display color values for each predesignated area of the first image;
map the each predesignated area to a pantone color code based upon the plurality of display color values associated with the each predesignated area;
convert the first image into a sequence of pantone color codes based on the mapping;
encode the sequence of pantone color codes into a matrix of values “0” and “1”;
transmit the matrix to a large language image classifier model;
prompt the large language image classifier model to classify the matrix into one of a first category or a second category;
output the first category or the second category to a user interface;
receive training data to indicate agreement or disagreement with the first category or the second category; and
adjust the large language image classifier model based on the training data.

2. The system of claim 1, wherein the each predesignated area includes a plurality of pixels, so that a length of the sequence of the pantone color codes is within a maximum dimension of the large language image classifier model.

3. The system of claim 1, wherein the first category indicates that the first image is within a predetermined criteria and the second category indicates that the first image is outside the predetermined criteria.

4. The system of claim 3, wherein the predetermined criteria comprises one or more of nudity, violence, illegal content, eating disorders, regulated products, abuse, bullying, and discriminatory.

5. The system of claim 1, wherein the encoding includes converting the sequence of pantone color codes into a series of color codes denoted by a combination of the values “0” and “1” to represent each pantone color code of the sequence of pantone color codes and creating the matrix of the series of color codes.

6. The system of claim 1, wherein the at least one processor is further configured to execute the machine executable instructions to:
establish a training dataset by repeatedly performing on a predetermined number of images:
obtain each of the predetermined number of images from the plurality of images;
extract a plurality of display color values for each predesignated area of the each of the predetermined number of images;
map the each predesignated area to a pantone color code based upon the plurality of display color values associated with the each predesignated area;
convert the each of the predetermined number of images into a sequence of pantone color codes based on the mapping;
convert the sequence of pantone color codes into a matrix of values “0” and “1”;
transmit the matrix to the large language image classifier model;
prompt the large language image classifier model to classify the matrix into a one of the first category or the second category;
output the first category or the second category to the user interface;
receive training data to indicate agreement or disagreement with the first category or the second category; and
adjust the large language image classifier model based on the training data.

7. The system of claim 1, wherein the at least one processor is further configured to execute the machine executable instructions to:
receive a plurality of classification images;
extract a plurality of display color values for each of the plurality of classification images;
map the each predesignated area to a pantone color code based upon the plurality of display color values associated with the each predesignated area;
convert each of the classification images into a sequence of pantone color codes based on the mapping;
convert the sequence of pantone color codes into a matrix of values “0” and “1”;
transmit the matrix to the large language image classifier model;
prompt, for each of the plurality of classification images, the large language image classifier model to classify the matrix into the first category or the second category; and
prohibit display of the plurality of classification images in the first category.

8. A computer implemented method for determining a label for a plurality of images, the method being executed by one or more processors and comprising:
obtaining a first image from a plurality of images;
extracting a plurality of display color values for each predesignated area of the first image;
mapping the each predesignated area to a pantone color code based upon the plurality of display color values associated with the each predesignated area;
converting the first image into a sequence of pantone color codes based on the mapping; encoding the sequence of pantone color codes into a matrix of values “0” and “1”;
transmitting the matrix to a large language image classifier model;
prompting the large language image classifier model to classify the matrix into one of a first category or a second category;
outputting the first category or the second category to a user interface;
receiving training data to indicate agreement or disagreement with the first category or the second category; and
adjusting the large language image classifier model based on the training data.

9. The computer implemented method of claim 8, wherein the each predesignated area includes a plurality of pixels, so that a length of the sequence of the pantone color codes is within a maximum dimension of the large language image classifier model.

10. The computer implemented method of claim 8, wherein the first category indicates that the first image is within a predetermined criteria and the second category indicates that the first image is outside the predetermined criteria.

11. The computer implemented method of claim 10, wherein the predetermined criteria comprises one or more of nudity, violence, illegal content, eating disorders, regulated products, abuse, bullying, and discriminatory.

12. The computer implemented method of claim 8, wherein the encoding includes converting the sequence of pantone color codes into a series of color codes denoted by a combination of the values “0” and “1” to represent each pantone color code of the sequence of pantone color codes and creating the matrix of the series of color codes.

13. The computer implemented method of claim 8, further comprising establishing a training dataset by repeatedly performing on a predetermined number of images:
obtaining each of the predetermined number of images from the plurality of images;
extracting a plurality of display color values for each predesignated area of the each of the predetermined number of images;
mapping the each predesignated area to a pantone color code based upon the plurality of display color values associated with the each predesignated area;
converting the each of the predetermined number of images into a sequence of pantone color codes based on the mapping;
converting the sequence of pantone color codes into a matrix of values “0” and “1”;
transmitting the matrix to the large language image classifier model;
prompting the large language image classifier model to classify the matrix into one of the first category or the second category;
outputting the first category or the second category to the user interface;
receiving training data to indicate agreement or disagreement with the first category or the second category; and
adjusting the large language image classifier model based on the training data.

14. The computer implemented method of claim 8, further comprising:
receiving a plurality of classification images;
extracting a plurality of display color values for each of the plurality of classification images;
mapping the each predesignated area to a pantone color code based upon the plurality of display color values associated with the each predesignated area;
converting each of the classification images into a sequence of pantone color codes based on the mapping;
converting the sequence of pantone color codes into a matrix of values “0” and “1”;
transmitting the matrix to the large language image classifier model;
prompting, for each of the plurality of classification images, the large language image classifier model to classify the matrix into the first category or the second category; and
prohibiting display of the plurality of classification images in the first category.

15. At least one non-transitory computer-readable medium (NTCRM) storing machine executable instructions thereon, which, when executed by at least one processor of a computing device, cause the computing device to:
obtain a first image from a plurality of images;
extract a plurality of display color values for each predesignated area of the first image;
map the each predesignated area to a pantone color code based upon the plurality of display color values associated with the each predesignated area;
convert the first image into a sequence of pantone color codes based on the mapping;
encode the sequence of pantone color codes into a matrix of values “0” and “1”;
transmit the matrix to a large language image classifier model;
prompt the large language image classifier model to classify the matrix into one of a first category or a second category;
output the first category or the second category to a user interface;
receive training data to indicate agreement or disagreement with the first category or the second category; and
adjust the large language image classifier model based on the training data.

16. The at least one NTCRM of claim 15, wherein the each predesignated area includes a plurality of pixels, so that a length of the sequence of the pantone color codes is within a maximum dimension of the large language image classifier model.

17. The at least one NTCRM of claim 15, wherein the first category indicates that the first image is within a predetermined criteria and the second category indicates that the first image is outside the predetermined criteria.

18. The at least one NTCRM of claim 17, wherein the predetermined criteria comprises one or more of nudity, violence, illegal content, eating disorders, regulated products, abuse, bullying, and discriminatory.

19. The at least one NTCRM of claim 15, wherein the encoding includes converting the sequence of pantone color codes into a series of color codes denoted by a combination of the values “0” and “1” to represent each pantone color code of the sequence of pantone color codes and creating the matrix of the series of color codes.

20. The at least one NTCRM of claim 15, wherein the at least one processor is further configured to execute the machine executable instructions to:
establish a training dataset by repeatedly performing on a predetermined number of images:
obtain each of the predetermined number of images from the plurality of images;
extract a plurality of display color values for each predesignated area of the each of the predetermined number of images;
map the each predesignated area to a pantone color code based upon the plurality of display color values associated with the each predesignated area;
convert the each of the predetermined number of images into a sequence of pantone color codes based on the mapping;
convert the sequence of pantone color codes into a matrix of values “0” and “1”;
transmit the matrix to the large language image classifier model;
prompt the large language image classifier model to classify the matrix into one of the first category or the second category;
output the first category or the second category to the user interface;
receive training data to indicate agreement or disagreement with the first category or the second category; and
adjust the large language image classifier model based on the training data.
